(19) United States
(12) Patent Application Publication
(10) Pub. No.: US 2010/0113734 A1
(43) Pub. Date: May 6, 2010

(54) PROCESS FOR PRODUCING POLYLACTIDE-URETHANE COPOLYMERS

(75) Inventors: Philippe Dubois, Ciplet (BE); Philippe Coszach, Escanaffles (BE); Gloria Vendrell, Bruxelles (BE); Fabrice Stassin, Watermael-Boitsfort (BE); Caroline Jourdanne, Proveysieux (FR); Luc Lienard, Valenciennes (FR); Philippe Degee, Hautrage (BE); Ibrahim Barakat, Wolume-St-Pierre (BE); Michael Alexandre, Ougree (BE); Jean Marie Raquez, Mons (BE)

Correspondence Address: FINA TECHNOLOGY INC, PO BOX 674412, HOUSTON, TX, 77267-4412, US

(73) Assignees: TOTAL PETROCHEMICALS RESEARCH FELUY, Seneffe (Feluy) (BE); FUTERRO S.A., Escanaffles (BE)

(21) Appl. No.: 12/442,478

(22) PCT Filed: Sep. 27, 2007
(86) PCT No.: PCT/EP2007/060274

§ 371 Date: Jan. 20, 2010

(30) Foreign Application Priority Data
Sep. 29, 2006 (EP) 06121559.6

(51) Int. Cl. C08G 18/00

(52) U.S. Cl. 528/80

(57) ABSTRACT

A process for producing polylactide-urethane copolymers, which comprises the step of contacting a polylactide having terminal hydroxyl groups, produced by contacting at least one lactide monomer with a diol or diamine, with a diisocyanate compound optionally in the presence of a second diol or diamine in the presence of a catalytic system under polymerisation conditions characterised in that the polylactide and the polylactide-urethane copolymers are produced by reactive extrusion.

The present invention relates to a process for producing biodegradable polylactide-urethane copolymers.

Polylactide-urethane copolymers are well known biodegradable polymers. Commercial interest for these polymers is increasing in many industrial applications.

Some processes for producing such copolymers are well known and fully described. However these processes can still be improved, particularly when polylactide-urethane copolymers with improved glass transition temperature is desired.

is WO 96/01863 discloses a poly(ester-urethane) resin, which may be prepared from a hydroxyl terminated poly(lactic acid) prepolymer and an aliphatic or an alicyclic diisocyanate. The said prepolymer is derived from the lactic acid and an aliphatic or an aromatic diol. This document does not refer to any reactive extrusion process.

The Derwent abstract of JP 04013710 A2 discloses a polyurethane resin obtained by the reaction of a micropolyol, at least part of which contains alphahydroxy acid, and a polyisocyanate with optionally the addition of a chain elongator. In an example, 1,4-butanediol and lactic acid were mixed and reacted at 150-200° C. for 6 hours to form both terminal diol (Mw=2,000). The diol (0.225 mole), 1,4-butanediol (0.733 mole) and diphenylmethane diisocyanate (0.987 mole) were reacted at 100° C. for 24 hours to obtain polyurethane. No reactive extrusion process is disclosed.

European Polymer Journal 42 (2006), pages 1240-1249, discloses the synthesis of a polylactide-based polyurethane prepared from a hydroxyl-terminated poly(lactide) prepolymer and hexamethylene diisocyanate in the presence of 1,4-butanediol. The said prepolymer is derived from lactide and 1,4-butanediol. No reactive extrusion process is disclosed.

The Derwent abstract of JP 8027256 A discloses a process for producing polylactide-urethane copolymers by contacting a polylactic acid diol with a diisocyanate compound in a screw extruder. The polylactic acid diol is prepared by copolymerising a lactic acid prepolymer with a diol compound in a batch reaction thank.

The Derwent abstract of JP 4013710 A discloses a polyurethane resin obtained by reaction of a micropolyol, at least part of which contains alphahydroxy acid, with a polyisocyanate and optionally in the presence of a chain elongator. An example in mode batch is disclosed wherein 1,4-butanediol and lactic acid were mixed and reacted for 6 hours to form a both-terminal diol containing alphahydroxy acid which was further reacted with 1,4-butanediol and diphenyl methane diisocyanate at 100° C. for 24 hours.

The Derwent abstract of JP 2002155197 A discloses a biodegradable heat resistant resin composition produced by blending a polylactic acid composition and an isocyanate compound. The polylactic acid composition is composed of a polylactic acid resin and one or more of e.g. polycaprolactone, polyester carbonate, polybutylene succinate resin.

WO 98/01493 discloses a process for producing copolyester based polyurethanes from lactic acid and another organic hydroxyl acid having a long flexible hydrocarbon chain in its molecules or corresponding lactone as ε-caprolactone. When said copolyester is melt blended with brittle biodegradable polymers, materials with significantly improved impact strength are produced.

It is an object of the present invention to provide a process for producing polylactide-urethane copolymers, which allows enhancing the glass transition temperature of said copolymers.

In the present invention, the term polylactide refers to a polymer in which the majority of repeating units are lactide-based monomers.

By biodegradable, it is meant that the resin is susceptible to degradation by microorganisms under natural conditions.

By reactive extrusion, it is meant that the polymerisation of the resin is carried out in an extruder.

By extruder, it is meant a system, suitable for continuously processing a thermoplastic polymer, equipped at least with a single or a twin-screw in a cylindrical barrel.

By bulk prepolymerisation or polymerisation, it is meant that the process occurs in the absence of solvent.

The present invention provides a process for producing polylactide-urethane copolymers, which process comprises the steps of contacting a polylactide having terminal hydroxyl groups with a diisocyanate compound of general formula O═C═N—R²—N═C═O wherein R² is a substituted or unsubstituted alkyl or aryl group, optionally in the presence of a second dial or diamine of general formula R³(A)₂ wherein A is OH or NH₂ and R³ is a substituted or an unsubstituted alkyl or aryl group in the presence of a catalytic system under polymerisation conditions characterised in that it is carried out by reactive extrusion.
The polylactide, used in the process of the invention, may be produced by contacting at least one lactide monomer with a diol or a diamine of general formula R¹(A)₂ wherein A is OH or NH₂ and R¹ is a substituted or an unsubstituted alkyl or aryl group in the presence of a catalytic system under polymerisation conditions.

Preferably, R¹ is an alkyl or an aryl group containing from 3 to 20 carbon atoms, preferably from 3 to 13 carbon atoms, more preferably from 6 to 13 carbon atoms. The alkyl or the aryl group may be substituted or not. The alkyl group may be linear, cyclic, saturated or unsaturated. Preferably, R¹ is an aryl group. The diol or the diamine is used as the initiator for the polymerisation of the lactide.

Among amines, one can cite 1,4-butanediamine, 1,6-hexanediamine, 1,4-cyclohexanediamine, 1,4-phenyldiamine, 4,4′-diaminodiphenylmethane, preferably 1,4-phenyldiamine or 4,4′-diaminodiphenylmethane is used.

Among alcohols, one can cite 1,3-propandiol, 1,3-butanediol, 1,4-butanediol, 1,6-hexanediol, 1,7-heptanediol, 1,8-octanediol, xylene glycol. Preferably, xylene glycol is used.

Preferably, the lactide used is a compound formed by the cyclic dimerisation of the lactic acid. The lactide exists in a variety of isomeric forms such as L, L-lactide, D, D-lactide and D, L-lactide. In the present invention, the L, L-lactide is preferably used. The lactide for use in the present invention may be produced by any process. A suitable process for preparing the L, L-lactide is for example described in patent application WO 2004/041889.

The concentration of lactide monomer and of initiator needed for producing the polylactide having terminal hydroxyl groups are determined according to the desired number average molecular weight of said polylactide. For example, if a desired number average molecular weight of the polylactide is 14,400 g/mol, the degree of polymerisation is 100 (14,400/144, 144 being the molecular weight of the lactide). Lactide and initiator are added in amounts such that the molar ratio of lactide to initiator is 100 to 1.
Usually, the polylactide having terminal hydroxyl groups has a number average molecular weight (Mn) comprised in the range from 3,000 to 20,000 g/mol, preferably in the range from 5,000 to 18,000 g/mol, more preferably in the range from 7,000 to 15,000 g/mol.

As diisocyanate compounds, one can cite the 1,6-hexamethylene diisocyanate (HMDI), the 4,4′-dicyclohexylmethane diisocyanate, the 4,4′-methylene diphenylisocyanate (MDI), the toluene diisocyanate (TDI), the p-phenylene diisocyanate. Preferably, the 4,4′-methylene diphenylisocyanate is used. The amount of diisocyanate to be added is such that the molar ratio between the isocyanate groups of the diisocyanate and the hydroxyl groups of the polylactide plus optionally the functional groups (OH or NH₂) of the extender is from 1 to 1.6, preferably from 1.2 to 1.4.

Optionally, a second diol or diamine represented by the general formula R³(A)₂ wherein A is OH or NH₂ and R³ is a substituted or an unsubstituted alkyl or aryl group may be added with the diisocyanate compound. R³ may be substituted or not. The alkyl group may be linear, cyclic, saturated or unsaturated. Preferably R³ is an aryl group. This second diol or diamine called herein extender may be the same or different from the diol or diamine used as initiator.

When a second diol or diamine is used, preferably the diol or the diamine is first mixed with the polylactide before introducing the diisocyanate compound.

Among examples of amines and alcohols that can be used as extender, one can cite those already mentioned here above which are suitable as initiator.

The amount of extender to be added is such that the molar ratio between the polylactide having terminal hydroxyl groups and the extender is in the range of from 40/60 to 75/25, preferably around 60/40.
The catalytic system used for producing the polylactide having terminal hydroxyl groups and the polylactide-urethane copolymers may be any suitable catalytic system. The catalytic system may contain at least one catalyst component of the formula:

(M)(X₁,X₂ . . . Xₘ)ₙ
wherein
M is a metal selected from groups 3-12 of the periodic system and from the elements Al, Ga, In, TI, Sn, Pb, Sb and Bi,
(Xm) is a substituent selected from one of the compound classes of alkyls, aryls, oxides, carboxylates, halogenides, and alkoxides and compounds containing elements from group 15 and/or 16 of the periodic system,
m is a whole number ranging from 1 to 6,
n is a whole number ranging from 0 to 6;
and at least one co-catalyst of the formula (Y)(R₁, R₂ R_{q})ₚ
wherein Y is an element selected from group 15 or 16 of the periodic system, (R₁, R₂ . . . R_{q}) is a substituent selected from one of the compound classes of alkyls, aryls, oxides, halogenides, oxyalkyls, aminoalkyls, thioalkyls, phenoxides, aminoaryls, thioaryls, q is a whole number ranging from 1 to 6, and p is a whole number ranging from 0 to 6.

As catalytic system, one can cite the combination of Sn-bis(2-ethylhexanoate) catalyst and triphenylphosphine (P(Ph)₃) co-catalyst. Such a catalytic system is well known and fully described in U.S. Pat. No. 6,166,169.

The molar ratio of the co-catalyst to the catalyst may range from 1/10 to 10/1, preferably from 1/3 to 3/1. An equimolar ratio between the co-catalyst and the catalyst is particularly preferable.

The catalytic system used allows on one hand the ring opening polymerisation of the lactide and on the other hand the condensation reaction between the hydroxyl-terminal groups of the polylactide and the NCO group of the diisocyanate compound.

According to one embodiment, the catalytic system used for producing the polylactide-urethane copolymers is the same as the one that was used to prepare the polylactide. This means that an additional amount of the same catalytic system, regarding that already used for the production of polylactide, may be added for producing polylactide-urethane copolymers.

According to another embodiment, the catalytic system used for producing polylactide-urethane copolymers is the catalytic system that was used to prepare polylactide. In this embodiment, no further addition of catalytic system occurs during the process for producing polylactide-urethane copolymers regarding that used for producing the polylactide.

The molar ratio of the lactide monomer to the catalyst and co-catalyst may range from 200/1 to 10,000/1, preferably from 1,000/1 to 7,500/1, more preferably from 1,750/1 to 5,250/1. According to a preferred embodiment the molar ratio of the lactide monomer to the catalyst and co-catalyst is about 5000/1.

Preferably, the polylactide having terminal hydroxyl groups is produced by reactive extrusion.

More preferably, the extruders used for producing the polylactide having terminal hydroxyl groups and the polylactide-urethane copolymers are interconnected.

Yet more preferably, the polylactide and the polylactide-urethane copolymers are produced by reactive extrusion in the same extruder. In this case, the production of polylactide prepolymer can be for example carried out in the first zones of the extruder via the introduction of lactide monomer and initiator in a first hopper and the production of polylactide-urethane copolymers can be carried out in downstream zones after adding a diisocyanate compound and optionally adding an extender in a second hopper.

The extruder may be a single-screw or a twin-screw extruder. Preferably, the extruder is a closely intermeshing co-rotating twin-screw extruder.

Preferably, the process for producing polylactide having terminal hydroxyl groups and polylactide-urethane copolymers are carried out in the absence of solvent.

Standard additives such as antioxidants and/or stabilizers may also be added during the reactive extrusion process. The antioxidant is generally introduced during the process for producing the polylactide having terminal hydroxyl groups. The stabilizer is generally introduced during the process for producing the polylactide-urethane copolymers.

### EXAMPLE AND COMPARATIVE EXAMPLE

In the example and comparative example, the average molecular weight by weight (Mw) and the average molecular weight by number (Mn) are determined by gel permeation chromatography with respect to polystyrene standards.

The glass transition temperature (Tg), the crystallisation temperature (Tc) and the melting temperature (Tm) are determined by differential scanning calorimetry (DSC) according to ISO 11357-2. In this method, the polylactide is first heated from 20° C. to 190° C., then cooled to 20° C. before to be heated a second time to 190° C. The first heating, the cooling and the second heating rates are at 10° C/min. Regarding the polylactide-urethane copolymers, those are heated from 20° C. to 190° C. and then cooled to 20° C., the heating and the cooling rates are at 10° C/min.

### 1.Comparative Example

A polylactide was first produced by using lactide monomer and 1,4-butanediol as initiator. The synthesis took place in a polymerisation tube at 160° C. in the presence of Sn-bis(2-ethylhexanoate) and triphenylphosphine. The molar ratio of the lactide monomer to the catalyst and co-catalyst was 2580. The characteristics of the prepolymer are mentioned in table 1. Thereafter, the synthesis of polylactide-urethane copolymers occurred in the polymerisation tube in the presence of hexamethylene diisocyanate at a temperature of 160° C. during 10 minutes in the presence of the catalytic system used for producing the polylactide. The amount of diisocyanate, which was added, was such that the molar ratio between the isocyanate groups of the diisocyanate and the hydroxyl groups of the polylactide was 1.
The characteristics of the polylactide (PLA) and polylactide-urethane copolymers (PLA/urethane) are displayed in table 1.

TABLE 1

| | | | DSC | | | |
|---|---|---|---|---|---|---|
| | Mn | | T_{g} | T_{c} (° C.) | Tₘ (° C.) | |
| code | 10³ g/mol | Mw/Mn | (° C.) | (ΔHc J/g) | (ΔHm J/g) | D_{cri} % |
| IBBA39 | 10.3 | 1.15 | n.d | n.d | 152 | nd |
| PLA | | | | | (51) | |
| IBBA53a | n.d | n.d | 45 | 88 | 145 | 24 |
| PLA/ | | | | (7) | (27) | |
| urethane | | | | | | |

n.d: not determined
Dcri %: degree of crystallisation, Dcri % = (ΔHm − ΔHc)/ΔHm(100%) wherein ΔHm(100%) = 83 j/g

### 2. Example According to the Invention

In a first example, the synthesis of polylactide-urethane copolymers took place in an extruder (Termo-Haake, double conical screw having a length of 109.5 mm, a screw diameter of 5 mm at the top and of 14 mm at the opposite side, volume 7 cm³, in co-rotation mode).

A polylactide having terminal hydroxyl groups (PLA) prepared from lactide monomers and 1,4 butanediol whose characteristics are mentioned in table 2 was used for the polymerisation of polylactide urethane copolymers. The polylactide and the diisocyanate compound were introduced into the extruder at a speed of 30 rpm during about 2 min. The speed of stirring was then increased to 70 rpm. Once all the ingredients were introduced into the extruder, the polymerisation lasted 10 min. Hexamethylene diisocyanate was added in such a quantity that the molar ratio between the isocyanate groups of the diisocyanate and the hydroxyl groups of the polylactide was 1.The polymerisation in the extruder took place at 160° C. during 10 minutes in the presence of Sn-bis(2-ethylhexanoate) and triphenylphosphine used for producing the polylactide. The results are displayed in table 2.

TABLE 2

| | | | DSC | | | |
|---|---|---|---|---|---|---|
| | Mn | | T_{g} | T_{c} (° C.) | Tₘ (° C.) | |
| Code | 10³ g/mol | Mw/Mn | (° C.) | (ΔHc J/g) | (ΔHm J/g) | D_{cri} % |
| IBBA42 | 8.8 | 1.40 | 41 | 98 | 149 | 55 |
| PLA | | | | (3) | (49) | |
| IBBA63i | 56 | 2.40 | 59 | 115 | 146 | 6 |
| PLA/ | | | | (13) | (18) | |
| urethane | | | | | | |

(ΔH J/g): enthalpy

One can see that when polylactide-urethane copolymers are produced by reactive extrusion, this leads to get copolymers with higher glass transition temperature.

Another example was carried out by reactive extrusion in two twin-screw extruders of type ZSK 35/56 from Collin characterised by a diameter of 35 mm and a length of 1,960 mm. There were 14 zones.

In a first extruder, polylactide was produced by introducing lactide monomer, 1,4-butanediol, Sn-bis(2-ethylhexanoate), triphenylphosphine and antioxidant (Ultranox® 626) at a feed rate of 1,200 g/h in zone 1 of the extruder. The molar ratio of lactide monomer to 1,4-butanediol was 35, the molar ratio of lactide monomer to catalyst and cocatalyst was 1/3000 and Ultranox® 626 was introduced in a quantity of 0.5 wt % of the lactide.
The temperature of the different zones were such as follows: zone 1:50° C., zone 2:80° C., zone 3:130° C., zones 4-13: 190° C., zone 14: 150° C., die 150° C. A polylactide having a Mn of 4,700 g/mol was produced.

The synthesis of polylatide-urethane copolymers was then carried out by reactive extrusion in a second twin-screw extruder of type ZSK 35/56 having the same characteristics as that previously used. The temperature of the different zones were as follows: zone 1:50° C., zone 2:80° C., zone 3:130° C., zones 4-13:190° C., zone 14:180° C., die:170° C.
Polylactide and stabilizer Irganox® MD 1024 were introduced in zone 1. Irganox® MD 1024 was introduced in a quantity such that the molar ratio of the stabilizer to the Sn of the catalyst is 1.
Hexamethylene diisocyanate was further introduced in zone 12 of the second extruder in a quantity such that the molar ratio between the isocyanate groups of the diisocyanate and the hydroxyl groups of the polylactide was 1.1. Polylactide-urethane copolymers were produced.

Another example was carried out wherein the production of polylactide and polylatide-urethane copolymers took place by reactive extrusion in the same twin-screw extruder of type ZSK 35/56 as previously described. The temperature of the different zones were as follows: zone 1:50° C., zone 2:80° C., zone 3:130° C., zones 4-13:190° C., zone 14:180° C., die:170° C.
All the reactants were introduced in the same quantities as those mentioned in the previous example where the extrusion took place in two twin-screw extruders of type ZSK 35/56. Lactide monomer, 1,4-butanediol, Sn-bis(2-ethylhexanoate), triphenylphosphine and antioxidant (Ultranox® 626) were first fed at a feed rate of 1,200 g/h in zone 1 of the extruder. Irganox® MD 1024 was introduced in zone 10 and hexamethylene diisocyanate was introduced in zone 12.
Polylactide-urethane copolymers were produced.

1. A process for producing polylactide-urethane copolymers, which comprises the step of contacting:
a polylactide having terminal hydroxyl groups, produced by contacting at least one lactide monomer with a diol or a diamine of general formula R¹(A)₂ wherein A is OH or NH₂ and R¹ is a substituted or an unsubstituted alkyl or aryl group in the presence of a catalytic system under polymerisation conditions with
a diisocyanate compound of general formula O═C═N—R²—N═C═O wherein R² is a substituted or unsubstituted alkyl or aryl group, optionally in the presence of a second diol or diamine of general formula R³(A)₂ wherein A is OH or NH₂ and R³ is a substituted or an unsubstituted alkyl or aryl group in the presence of a catalytic system under polymerisation conditions characterised in that the polylactide and the polylactide-urethane copolymers are produced by reactive extrusion.

2. A process according to claim 1, wherein the catalytic system used for producing the polylactide-urethane copolymers is the same as the one that was used to prepare the polylactide.

3. A process according to claim 2, wherein the catalytic system used for producing the polylactide-urethane copolymers is the catalytic system that was used to prepare the polylactide.

4. A process according to claim 1 characterised in that the extruder used for producing the polylactide and the extruder used for producing the polylactide-urethane copolymers are interconnected extruders.

5. A process according to claim 1 characterised in that the polylactide and the polylactide-urethane copolymers are produced by reactive extrusion in the same extruder.

6. A process according to claim 1 characterised in that it is carried out in the absence of solvent.
